(19) United States
(12) Patent Application Publication
(10) Pub. No.: US 2025/0245551 A1
(43) Pub. Date: Jul. 31, 2025

(54) PREDICTIVE INTELLIGENCE FOR CLOUD TIERING WORKFLOW

(71) Applicant: Dell Products L.P., Round Rock, TX (US)

(72) Inventors: Shashank Prakash Khobragade, Nagpur (IN); Santi Gopal Mondal, Bangalore (IN); Swapnil Ramteke, Gadchiroli (IN); Chakitha Saraswathi, Bengaluru (IN)

(21) Appl. No.: 18/424,334

(22) Filed: Jan. 26, 2024

(51) Int. Cl. G06N 20/00; G06F 16/11; G06F 16/17; G06F 16/174

(52) U.S. Cl. CPC G06N 20/00; G06F 16/119; G06F 16/1734; G06F 16/1748

(57) ABSTRACT

Statistics corresponding to parameters associated with a workflow to transfer files from one of a deduplicated storage appliance or cloud storage to another of the deduplicated storage appliance or the cloud storage is monitored. Upon detecting that resource utilization on the storage appliance has remained below a threshold for a period of time, a forecast is made of predicted values corresponding to the parameters over a duration of time that the workflow is expected to run. The predicted values are checked against trigger conditions. Upon the predicted values satisfying at least some of the trigger conditions, the workflow is triggered.

### TECHNICAL FIELD

The present invention relates generally to information processing systems, and more particularly to workflows involving storage appliances and cloud storage.

### BACKGROUND

Many enterprises rely on storage appliances to backup and protect their data. A storage appliance contains its own hardware, operating system, file system, and programs designed for reliable data storage and retrieval. The file system may include a deduplicated file system. File systems provide a way to organize data stored in storage and present that data to clients. A deduplicated file system is a type of file system that seeks to reduce the amount of redundant data that is stored. Generally, data that is determined to already exist on the storage system is not again stored. Instead, metadata including references is generated to point to the already stored data and allow for reconstruction. Using a deduplicated file system with a backup storage system can be especially attractive because backups often include large amounts of redundant data that do not have to be again stored thereby reducing storage costs. A large-scale deduplicated file system may hold many millions of files along with the metadata required to reconstruct the file.

In addition to backing up data from clients, a backup data storage appliance may support a variety of other operations on the files such as copying the files to a different location for purposes of replication, long term retention and storage, or other. These operations consume resources which can have an impact on the overall performance of the appliance. There is a need for improved systems and techniques of scheduling such operations.

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions.

### BRIEF SUMMARY

Statistics corresponding to parameters associated with a workflow to transfer files from one of a deduplicated storage appliance or cloud storage to another of the deduplicated storage appliance or the cloud storage is monitored. Upon detecting that resource utilization on the storage appliance has remained below a threshold for a period of time, a forecast is made to predicted values corresponding to the parameters over a duration of time that the workflow is expected to run. The predicted values are checked against trigger conditions. Upon the predicted values satisfying at least some of the trigger conditions, the workflow is triggered.

### BRIEF DESCRIPTION OF THE FIGURES

In the following drawings like reference numerals designate like structural elements. Although the figures depict various examples, the one or more embodiments and implementations described herein are not limited to the examples depicted in the figures.

FIG. 1 shows a block diagram of an information processing system for predictive intelligence in a deduplicated storage system appliance, according to one or more embodiments.

FIG. 2 shows a block diagram of an operation involving moving files from a storage location to a different storage location, according to one or more embodiments.

FIG. 3 shows an example of a cloud tiering or migration workflow, according to one or more embodiments.

FIG. 4 shows a flow of predictive intelligence for a cloud tiering workflow, according to one or more embodiments.

FIG. 5 shows an example of heuristics or metrics dumped by a monitoring module, according to one or more embodiments.

FIG. 6 shows an example of a threshold map, according to one or more embodiments.

FIG. 7 shows a flow for predictive intelligence for a cloud tiering or recall workflow, according to one or more embodiments.

FIG. 8 shows a flow for making predictions, according to one or more embodiments.

FIG. 9 shows a flow for a predefined workflow schedule being used in conjunction with predictive intelligence, according to one or more embodiments.

FIG. 10 shows a block diagram of a processing platform that may be utilized to implement at least a portion of an information processing system, according to one or more embodiments.

FIG. 11 shows a block diagram of a computer system suitable for use with the system, according to one or more embodiments.

### DETAILED DESCRIPTION

A detailed description of one or more embodiments is provided below along with accompanying figures that illustrate the principles of the described embodiments. While aspects of the invention are described in conjunction with such embodiment(s), it should be understood that it is not limited to any one embodiment. On the contrary, the scope is limited only by the claims and the invention encompasses numerous alternatives, modifications, and equivalents. For the purpose of example, numerous specific details are set forth in the following description in order to provide a thorough understanding of the described embodiments, which may be practiced according to the claims without some or all of these specific details. For the purpose of clarity, technical material that is known in the technical fields related to the embodiments has not been described in detail so that the described embodiments are not unnecessarily obscured.

It should be appreciated that the described embodiments can be implemented in numerous ways, including as a process, an apparatus, a system, a device, a method, or a computer-readable medium such as a computer-readable storage medium containing computer-readable instructions or computer program code, or as a computer program product, comprising a computer-usable medium having a computer-readable program code embodied therein. In the context of this disclosure, a computer-usable medium or computer-readable medium may be any physical medium that can contain or store the program for use by or in connection with the instruction execution system, apparatus or device. For example, the computer-readable storage medium or computer-usable medium may be, but is not limited to, a random access memory (RAM), read-only memory (ROM), or a persistent store, such as a mass storage device, hard drives, CDROM, DVDROM, tape, erasable programmable read-only memory (EPROM or flash memory), or any magnetic, electromagnetic, optical, or electrical means or system, apparatus or device for storing information. Alternatively or additionally, the computer-readable storage medium or computer-usable medium may be any combination of these devices or even paper or another suitable medium upon which the program code is printed, as the program code can be electronically captured, via, for instance, optical scanning of the paper or other medium, then compiled, interpreted, or otherwise processed in a suitable manner, if necessary, and then stored in a computer memory. Applications, software programs or computer-readable instructions may be referred to as components or modules. Applications may be hardwired or hard coded in hardware or take the form of software executing on a general purpose computer or be hardwired or hard coded in hardware such that when the software is loaded into and/or executed by the computer, the computer becomes an apparatus for practicing the invention. Applications may also be downloaded, in whole or in part, through the use of a software development kit or toolkit that enables the creation and implementation of the described embodiments. In this specification, these implementations, or any other form that the invention may take, may be referred to as techniques. In general, the order of the steps of disclosed processes may be altered within the scope of the invention. Aspects of the one or more embodiments described herein may be implemented on one or more computers executing software instructions, and the computers may be networked in a client-server arrangement or similar distributed computer network. In this disclosure, the variable N and other similar index variables are assumed to be arbitrary positive integers greater than or equal to two. It should be appreciated that the blocks, components, and modules shown in the figures may be functional and there can be many different hardware configurations, software configurations, or both to implement the functions described.

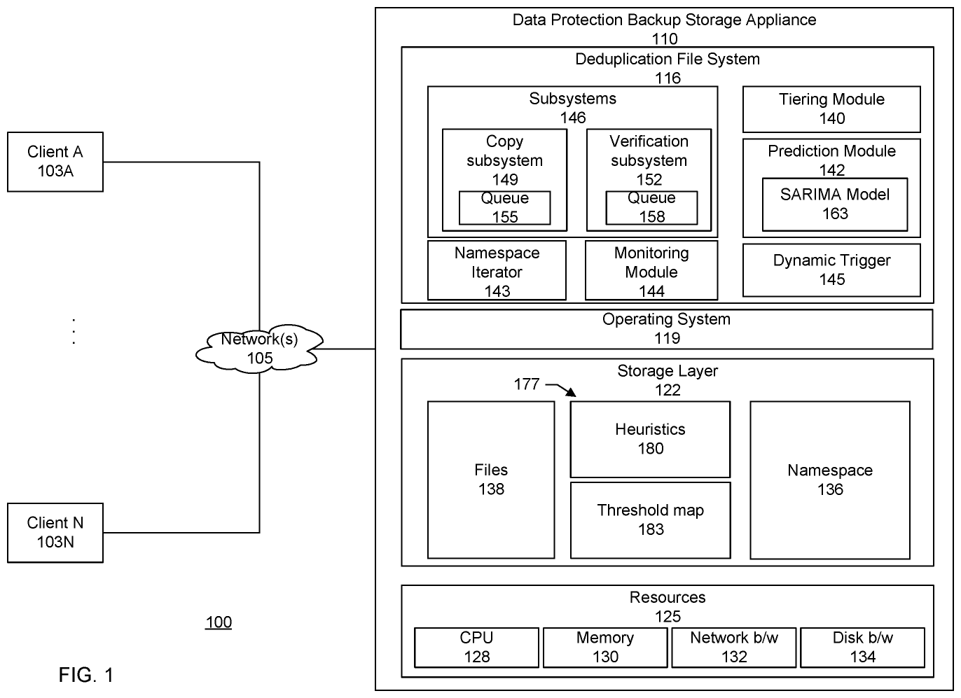

FIG. 1 shows a block diagram of an information processing system 100 within which methods and systems for predictive intelligence for a cloud tiering or recall workflow may be implemented. As shown in the example of FIG. 1, clients 103A-N of an organization are connected via a network 105 to a data protection backup storage appliance 110. In an embodiment, the storage appliance provides a secondary storage system for data (e.g., files) generated by the clients. Files stored on primary storage of the clients may be periodically backed up to the storage appliance. In an embodiment, the storage appliance may reside locally in a data center managed by the organization.

The storage appliance may include a file system 116, operating system 119, storage layer 122, and resources 125. Resources may include any number of central processing units (CPUs) 128, memory 130, network bandwidth 132, disk bandwidth 134, or other resources. These resources may be used or consumed by the file system including components of the storage appliance and other programs when performing an operation, providing a service, or executing a workflow. For example, backing up files from the clients to the storage appliance requires CPU cycles, memory resources, network bandwidth, processing threads, disk utilization, and so forth as backup code and logic is executed, data is transferred over the network, and data is written to disk. The operating system is responsible for managing the resources and their access. The resources may be shared across the various processes, components, modules, services, subsystems, or code components of the storage appliance.

The file system provides a way to organize data stored at the storage layer and present that data to clients and applications in a logical format. The file system organizes the data into files and folders into which the files may be stored. When a client requests access to a file, the file system issues a file handle or other identifier for the file to the client. The client can use the file handle or other identifier in subsequent operations involving the file. A namespace 136 of the file system provides a hierarchical organizational structure for identifying file system objects through a file path. A file can be identified by its path through a structure of folders and subfolders in the file system. A file system may hold many hundreds of thousands or even many millions of files across many different folders and subfolders and spanning thousands of terabytes.

In an embodiment, the file system is a deduplicated file system. An example of a deduplicated file system includes a Data Domain File System (DDFS) as provided by Dell Technologies of Round Rock, Texas. Deduplication involves splitting a file to be written to the storage system into a set of segments and comparing fingerprints of the segments against fingerprints corresponding to segments that have previously already been stored and are present at the storage system. Segments of the file having matching fingerprints are considered redundant and do not have to be again stored. Segments of the file that do not have matching fingerprints are considered new and are stored. Metadata including references is generated to allow the file to be reassembled. In an embodiment, this process of accepting incoming files from the clients may be referred to as ingestion.

Storage of the backup data storage appliance include files 138, the namespace, and other metadata. Storage may include storage servers, clusters of storage servers, network storage device, storage device arrays, storage subsystems including RAID (Redundant Array of Independent Disks) components, a storage area network (SAN), Network-attached Storage (NAS), or Direct-attached Storage (DAS) that make use of large-scale network accessible storage devices, such as large capacity tape or drive (optical or magnetic) arrays, shared storage pool, or an object or cloud storage service. In an embodiment, storage (e.g., tape or disk array) may represent any practical storage device or set of devices, such as tape libraries, virtual tape libraries (VTL), fiber-channel (FC) storage area network devices, and OST (OpenStorage) devices. The storage may include any number of storage arrays having any number of disk arrays organized into logical unit numbers (LUNs). A LUN is a number or other identifier used to identify a logical storage unit. A disk may be configured as a single LUN or may include multiple disks. A LUN may include a portion of a disk, portions of multiple disks, or multiple complete disks. Thus, storage may represent logical storage that includes any number of physical storage devices connected to form a logical storage.

The files correspond to data that has been backed up from the clients. These backup files or backup data may be stored in a format that is different from a native format of the primary file copies at the clients. For example, the backups may be stored in a compressed format, deduplicated format, or both. The namespace stores metadata associated with the files and tracks the various deduplicated segments of the files. In an embodiment, the file system metadata such as the names of files and their attributes is stored in a hierarchical tree data structure such as a B tree or B+ tree. The tree can have any number of levels. For example, there can be a root level, a leaf level, and one or more intermediate levels between the root and leaf levels. Pages in the intermediate levels store references to pages at the leaf level which then address or point to actual file data or content. Thus, in a large-scale deduplicated file system, a single intermediate page can reference many thousands of leaf pages.

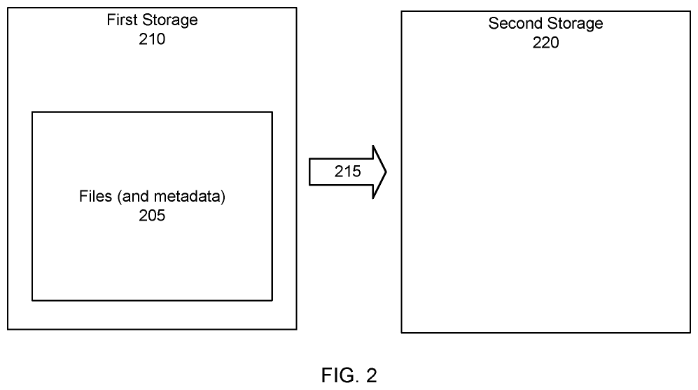

Files stored at the backup storage appliance may be moved, copied, or replicated to different storage. For example, FIG. 2 shows a block diagram of files (and associated metadata) 205 residing at a first storage 210 being moved 215 to a second storage 220. The first and second storages may represent different tiers of storage. Different storage tiers may have different types of storage devices. For example, recently backed up files may be placed in a first tier having high performance storage devices (e.g., solid state drives (SSDs)) as files recently backed up may be more likely to be accessed as compared to files from older backups. As backups age or frequency of access decreases, the files may be transferred from the first tier to a second tier having lower performance, but less expensive storage devices (e.g., hard disk drives (HDDs)).

In an embodiment, the first storage is referred to as an active tier and the second storage is referred to as a cloud tier. In this embodiment, the active tier includes the actual file copies. Initial backups from the clients are stored in the active tier via process that may be referred to as ingestion. As these backups or secondary copies age, the backups may be moved or transferred to cloud storage as represented by the cloud tier. Moving or transferring files from the storage appliance to cloud storage may be referred to as cloud tiering or cloud migration workflow.

Cloud storage from cloud storage providers can offer organizations economical storage of data. Some examples of cloud storage providers or public clouds include Amazon Web Services® (AWS Cloud) as provided by Amazon, Inc. of Seattle, Washington; Microsoft Azure® as provided by Microsoft Corporation of Redmond, Washington; Google Cloud® as provided Alphabet, Inc. of Mountain View, California; and others. The cloud storage provider makes resources available as services to its tenants over the network (e.g., internet). The cloud storage provider, however, is responsible for the underlying infrastructure. For example, Amazon Simple Storage Service (S3) provides storage for customer data in object storage. Data, such as files, may be stored as objects in logical containers referred to as buckets.

As another example, the first and second storages may represent different geographical sites. For example, the first storage may represent an on-site data center of an enterprise while the second storage may represent a remote off-site storage location. Files may be replicated from the first storage to the second storage for purposes of disaster recovery.

In an embodiment, workflows including data movement operations such as moving or transferring certain files from the storage appliance to a cloud are triggered based on evaluation of polices. Such a workflow may be referred to as cloud tiering or cloud migration. The policies may be configured by a user of the data storage appliance. For example, a policy can specify one or more criteria or conditions for when files should be moved or migrated from the storage appliance to cloud storage. The conditions may include, for example, an age of a file or time that the file has remained in the active tier of the storage appliance, business unit of the organization that owns the file, date the file was last recalled from the backup storage appliance to a client, size of a file, directory that the file resides in, type of file (e.g., database), other conditions, or combinations of these. Alternatively, a data movement operation for one or more files may be triggered on-demand, such as via a request from the user. The policies are evaluated by the data storage appliance to identify files eligible for various workflows (e.g., data movement operations).

In an embodiment, cloud long term storage classes, being an ideal choice for long term retention, are used by secondary storage systems as cold storage. Cloud tiering workflows ensure that eligible files are migrated in each cycle, thereby making space for new data on local storage. The tiering is generally scheduled by the end-user for periodic automatic invocation. The periodic migration runs are expected to migrate data before files expire the retention period and local storage runs out of space.

Additionally, for optimal or good resource utilization, the tiering schedule is expected to have minimal or little overlap, if not zero, with other long running workflows like garbage collection and replication. Manually set schedules are often observed to fail these requirements which impacts backup service level agreements (SLAs). Unprecedented migration run failures may create a backlog of eligible data. The absence of any estimation on run time may lead to defiance of the assumptions made to avoid overlap between long running jobs.

Also, a schedule set with high periodic frequency can cause metadata bloat, while low frequency can lead to active space full scenarios in addition to files expiring retention period as migration runs are too far apart. In an embodiment, systems and techniques are provided that build predictive intelligence for a cloud tiering, cloud migration, or other data movement workflow. Predictive intelligence may be used to estimate the time required for a particular job or workflow (e.g., cloud tiering or cloud migration workflow). In an embodiment, the predictive intelligence technique performs statistical time series predictions to identify an optimal or desirable time window for automatically triggering data-movement operations. The predictive intelligence technique helps to ensure timely migration of data, optimal or good use of resources, and avoidance of space-full scenarios as well as inefficient metadata space utilization.

Statistical models such as Seasonal Auto-Regressive Integrated Moving Average (SARIMA) may be used to predict data-movement statistics (such as run-time, count of files to be migrated, total pre-compression and post-compression of data to be tiered), resource utilization (e.g., CPU, memory, disk and network bandwidth), and capacity utilization (active and cloud). The predictions are made by training the model with heuristics generated periodically by the system. The predicated values may also be used to provide an approximate estimation on migration run time and other migration statistics for an enhanced user experience.

Referring back now to FIG. 1, in an embodiment, the file system includes a tiering module 140, prediction module 142, namespace iterator 143, monitoring module 144, dynamic trigger 145, and any number of subsystems 146.

The monitoring module is responsible for collecting utilization information or metrics indicating demand on or usage of resources. The data, statistics, or metrics gathered by the monitoring module may be used to train the prediction model. Resource utilization may include a measurement of various parameters including network usage, disk activity or utilization, memory utilization, CPU cycles, disk latency, or other resource. For example, disk utilization may be expressed as disk busy percentage (%) which represents a percentage of elapsed time when the disk was busy processing a read or write request. The monitoring module may gather such metrics by, for example, communicating with the operating system. The monitoring module may gather performance logs that may be maintained by various resources of the storage appliance to track utilization.

Examples of resource utilization data, metrics, or counters include percentage disk read time (amount of time disks are being read), percentage disk time (amount of time disks are in use), percentage disk write time (amount of time disks are being written to), percentage idle time (amount of time disks are idle or not performing any action), current disk queue length (amount of time the operating system must wait to access the disks), disk reads/second (overall rate of read operations on the disk), disk writes/second (overall rate of write operations on the disk), split IO/second (overall rate at which the operating system divides I/O requests to the disk into multiple requests), and others.

CPU utilization refers to a computer's usage of processing resources, or the amount of work handled by a CPU. Actual CPU utilization varies depending on the amount and type of managed computing tasks. Certain tasks require heavy CPU time, while others require less because of non-CPU resource requirements.

Network bandwidth may be measured with respect to throughput, latency, jitter, packet loss, other metric, or combinations of these. Throughput measures the amount of data that can be transmitted over a network in a given period of time. Throughput may be expressed in bits per second (bps), kilobits per second (Kbps), or megabits per second (Mbps). Latency measures the time required for a packet of data to travel from one point on a network to another. Latency may be expressed in milliseconds (ms). Jitter measures the variation in the delay of packets as they travel across a network. Jitter may be expressed in milliseconds (ms). Packet loss measures the percentage of packets that are lost or do not arrive at their destination. Packet loss may be expressed as a percentage.

Memory may be measured with respect to usage, utilization, page file usage, other metric, or combinations of these. Memory usage or utilization measures the amount of memory that is being used by applications and system processes. Memory usage may be expressed in bytes, kilobytes (KB), megabytes (MB), or gigabytes (GB). Memory utilization can indicate the percentage of available memory that is currently being used. Memory utilization may be calculated by dividing the amount of memory that is currently being used by the total amount of available memory and multiplying by 100 percent. Page file usage measures the amount of virtual memory that is being used by applications and system processes. Page file usage may be expressed in bytes, KB, MB, or GB.

Other parameters collected by the monitoring module relate to the data subject to the workflow such as a count of the number of files eligible for migration, size of the files, pre-compression size of the files, post-compression size of the files, storage space consumed on the active tier, store space remaining on the active tier, or other parameter, and combinations of these. The monitoring module may be configured to sample different types of parameters at different frequencies. For example, CPU utilization may be sampled at a first frequency. Disk capacity may be sampled at a second frequency, different from the first frequency. The first frequency may be higher than the second frequency as CPU utilization may change more frequently than disk capacity.

The statistics or metrics collected by the monitoring module are dumped to disk as heuristics 180.

A threshold map 183 specifies parameters and corresponding thresholds against which the predicted or forecasted values are compared to determine whether a data movement workflow should be triggered. The parameters and corresponding thresholds in the threshold map may be referred to as trigger conditions.

The subsystems carry out various operations and workflows on files managed by the backup storage appliance. For example, there can be a copy subsystem 149, a verification subsystem 152, or other subsystem (e.g., recall subsystem). The subsystems include queues 155, 158, respectively. The queue provides for a temporary holding, staging, or buffering of files (or file regions) that are to be processed by one or more threads initiated by a respective subsystem. Each thread may be associated with a job.

In particular, the copy subsystem is responsible for workflows involving the copying of files including associated metadata to a different location. For example, files eligible for cloud storage may be moved from the storage appliance (e.g., source) to the cloud (e.g., destination). The verification subsystem is responsible for workflows involving verifying that the files, associated metadata, or both have been properly copied to the destination. Such verification may include, for example, reading the data copied to the destination, calculating checksums of the data, and comparing the checksums to checksums calculated before the copying. Verification is especially important in a deduplicated file system due to the importance that metadata plays in such a system. For example, a corruption in an intermediate level page of a tree structure storing the namespace of the file system can result in many thousands of files referenced by the intermediate page being unreachable. Verification can help ensure that file data is reachable through pointers, references, or other metadata. Thus, once a file or other unit of data has been copied to cloud storage by the copy subsystem, the unit of data is then input to the verify subsystem (e.g., placed onto the verify subsystem queue) to ensure that the unit of data was copied correctly.

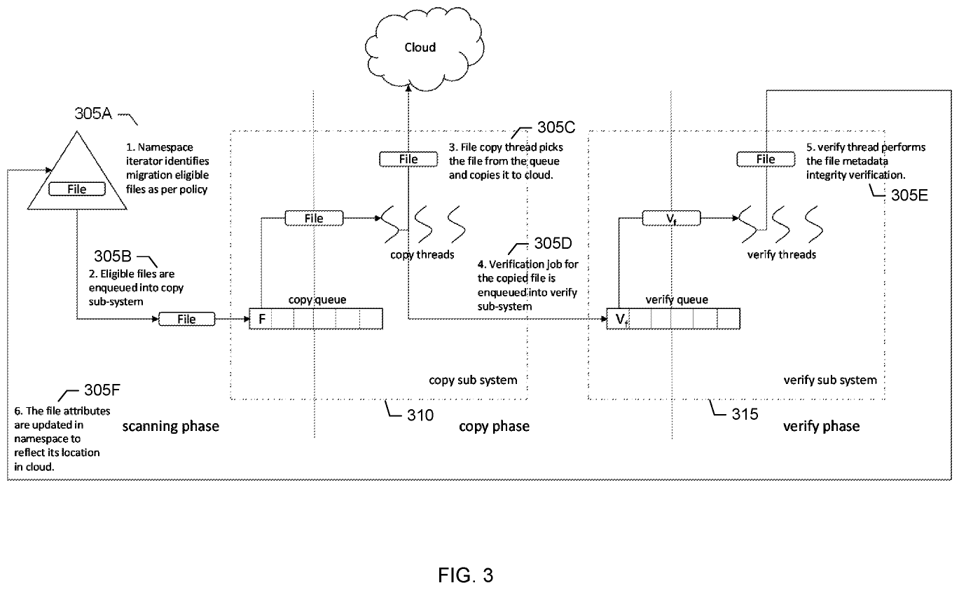

FIG. 3 shows an example of a cloud tiering workflow. In an embodiment, secondary deduplicated (de-dup) storage systems migrate backup data to the cloud tier as it is cost effective, ideal for long term retention, and safe from local disasters.

The migration can be logical, where each eligible file is migrated to cloud individually. Alternatively, the migration can be physical, where data of eligible files is seeded in bulk. For logical file level migrations, generally, an eligibility policy is used to identify files eligible for migration to cloud tier. Some of examples of policies include age-based policies, age-range policies, and application managed policies. Age-based policies identify files older than a specified threshold as being eligible. Age-range policies identify files with an age between the given range as being eligible. Application (app)-managed policies rely on a backup application that marks files individually for migration which in-turn could be age-based.

A cloud migration workflow may be managed by the tiering module and may involve the namespace iterator, copy sub-system, and verify sub-system. More particularly, in a step 305A, the namespace iterator identifies eligible files as per the policy. In a step 305B, the files satisfying eligibility criteria per conditions in the police are enqueued into a copy sub-system 310. In a step 305C, the copy sub-system copies the eligible files to the cloud tier. In particular, file copy threads pick the file from the copy queue and copies it to the cloud. In a step 305D, the copy sub-system enqueues a metadata verify job into a verify sub-system 315. In a step 305E, the verify sub-system verifies metadata integrity and initiates namespace update. In a step 305F, the file location is then updated as “cloud” in the namespace.

Referring back now to FIG. 1, in an embodiment, the prediction module uses a statistically-based seasonal-autoregressive integrated moving average (SARIMA) model 163 to forecast values for parameters associated with a workflow. In an embodiment, the workflow includes one of a cloud tiering or recall/restore workflow. As discussed, the cloud tiering workflow transfers files from the storage appliance to cloud storage. The recall or restore workflow is a reverse of the cloud tiering workflow in that files previously transferred to cloud storage are recalled back to the storage appliance.

Autoregressive integrated moving average (ARIMA) models predict future values based on past values. ARIMA makes use of lagged moving averages to smooth time series data. More particularly, ARIMA f(p,d,q) based time-series predictions train over a univariate data-set. The auto-regressive component derives a value based on past patterns, integration makes series stationary with differencing, and moving average accounts for the residual error between past forecasted values and actual value.

The auto regression refers to variable regressing over liner combination of its past values. The order of auto-regression is specified with “p” which signifies current value as liner function of past “p” values. The Auto-Correlation Function (ACF) and Partial Auto-Correlation Function (PACF) can be used to derive the order of auto-regression.

$${y}_{t} = 0 + {α}_{1} {y}_{t - 1} + {α}_{2} {y}_{t - 2} + {α}_{3} {y}_{t - 3} + … + {α}_{p} {y}_{t - p}$$

The “integrated” part of the model refers to differencing, specified with “d”, that can be applied to make the time series stationary (independent of the time when observations were made). The Dickey-Fuller test can be used to check if the series is stationary or not.

The “moving average” component, specified with “q”, is not a rolling average over the variable but rather a lagged deviation between past forecasted values and actual target value.

$${ε}_{t} = 0 + {β}_{1} {ε}_{t - 1} + {β}_{2} {ε}_{t - 2} + {β}_{3} {ε}_{t - 3} + … + {β}_{p} {ε}_{t - q}$$

The SARIMA (f(p,d,q), g(P,D,Q)ₛₙ) model in addition to ARIMA components of auto-regression, differencing, and moving average, has additional auto-regression, differencing, and moving average components to account seasonality specified with “P”, “D”, “Q”, and “sn” where “sn” is the seasonal frequency. The seasonal components are lagged as per seasonal frequency.

$${y}_{t} = c + {\sum }_{n = 1}^{p} {α}_{n} {y}_{t - n} + {\sum }_{n = 1}^{q} {β}_{n} {ε}_{t - n} + {\sum }_{n = 1}^{P} {θ}_{n} {y}_{t - sn} + {\sum }_{n = 1}^{Q} {φ}_{n} {ε}_{t - sn} + {ε}_{t}$$

Cloud tiering may be invoked either on-demand by the end-user or periodically with a predefined schedule. Though the recommended frequency is weekly, it can be configured to be every n-days or n-weeks. For efficient migration-cycles, the tiering frequency should not be too high or too low. Additionally, it is desirable to mitigate inefficient system resource and metadata space utilization. Manually configured schedules often fail these requirements leading to several problems such as an imbalance between tiering and ingest. More specifically, cloud storage may be configured late and at a time when the local active tier of the storage appliance already has a lot of data. Migration and ingest rate need to be balanced such that enough space is freed with tiering, thereby allowing new data from the clients to be stored at the storage appliance. An imbalance may lead to active space getting full. Multiple consecutive migration run failures generates a huge backlog, which may again lead to active space-full scenarios. Additionally, delayed tiering also poses a risk of files expiring retention period.

Another problem with manually configured scheduling includes inefficient metadata space utilization. On some platforms, the active tier capacity may be low because the migration periodicity may be set to “daily.” The low migration chum leads to inefficient metadata space utilization as the container writes suffer from a partial fullness problem.

Another problem with manually configured scheduling includes sub-optimal system resource utilization. Even though the schedule might be configured to account for different long-running jobs to ensure the overlap is at a minimum or otherwise low, the schedule does not re-calibrate as per change in run time of long-running jobs. For example, if a lot of data is eligible for migration because of prior run failures or a higher ingest rate, a migration run may take a longer time to complete than expected. This may cause overlapping with other long-running jobs, leading to inefficient resource utilization.

Another problem with manually configured scheduling includes a lack of run level statistics estimation. The namespace enumeration operation for cloud migration that identifies migration eligible files can be a long-running and computationally expensive activity as the system may have millions of files. For this reason, tiering workflows may block enumeration if the migration sub-systems become exhausted. In the absence of total migration eligible file statistics, the end-user is provided with incremental status without any information on total time to complete the run or increment to be observed in the cloud space utilization. This leads to a bad user experience.

In an embodiment, systems and techniques solve the migration scheduling problem using statistical predictions with which an ideal or good window for migration can be identified. The migration run can then be automatically triggered in this time window. In an embodiment, systems and techniques use predicted migration statistics for approximate estimations which can be reported to the end-user thereby enhancing the user experience.

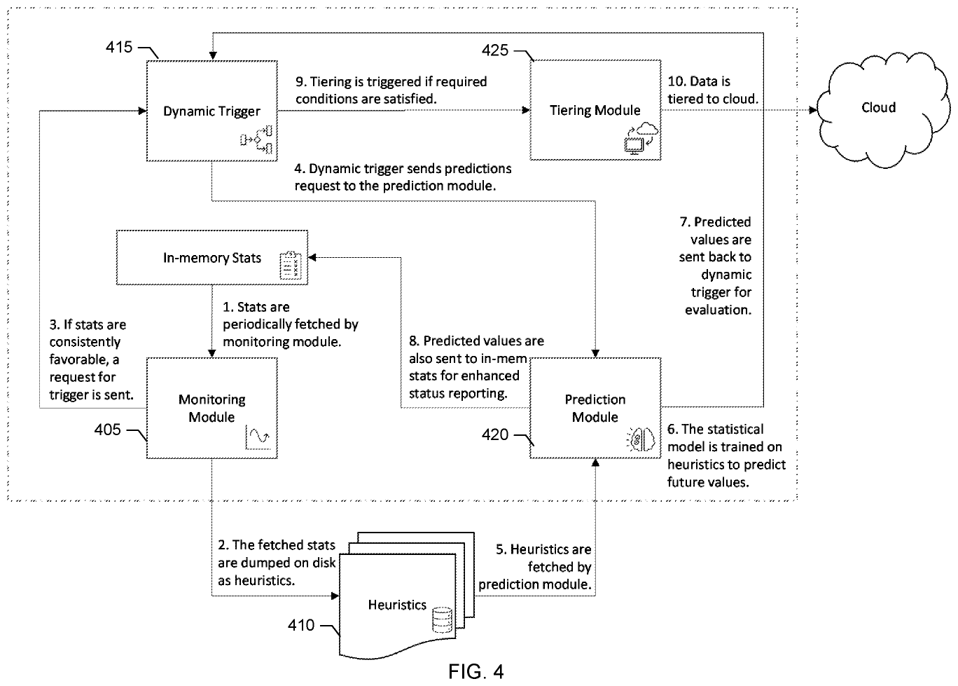

FIG. 4 shows a flow diagram for predictive intelligence for a cloud tiering workflow. In an embodiment, there is a monitoring module 405 which periodically fetches statistics (stats) or metrics of interest and dumps them on persistent storage as heuristics 410. If the resource utilization is found to be below threshold for a predefined period, the monitoring module requests a dynamic trigger 415 to take a decision on a data-movement invocation. Dynamic trigger requests a prediction module 420 to predict future values for various parameters based on which the decision to trigger data-movement is taken. The prediction module trains on a subset of the collected heuristics or metrics, tests accuracy on a rest or remaining portion of the dataset, re-calibrates orders of the statistical model, predicts future values, and returns the forecasted values back to dynamic trigger for each parameter. The dynamic trigger then evaluates the predictions to identify an optimal or desirable time window for data-movement and accordingly takes a decision on automatic invocation of a cloud tiering module 425.

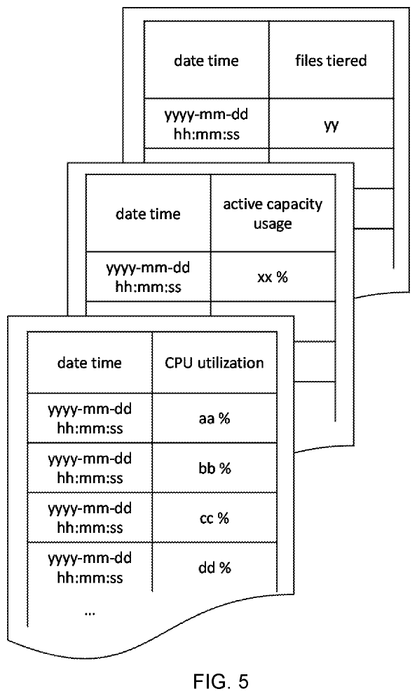

More particularly, the monitoring module periodically fetches and dumps statistics or metrics of interest such as migration statistics, resource and capacity utilization. FIG. 5 shows an example of heuristics dumped by the monitoring module. The said resources consumption corresponds to system resources such as CPU, memory, network bandwidth, disk bandwidth, and the like. Capacity consumption refers to active and cloud capacity usage.

The periodic frequency at which the monitoring module collects statistics can be different for different parameters. For example it can be a few minutes for resource utilization whereas for capacity utilization it can be every few hours or even daily. In order to handle frequent variations in heuristics, the monitoring module can keep track of fluctuations in a last x minutes, thereby ensuring a set of stable heuristics concerning resource availability and avoiding spurious values. The monitoring module, upon observing that the resource utilization has remained consistently low for a period of time, sends a request to the dynamic trigger to make a decision on invocation.

In an embodiment, the dynamic trigger makes a forecast request to the prediction module for each evaluation parameter for a next n days. The predicted values are used to make a decision on whether to trigger data-movement or not. The dynamic trigger maintains a threshold map to refer to and determine whether the predicted values are within bounds. The threshold values can be configured by end-user.

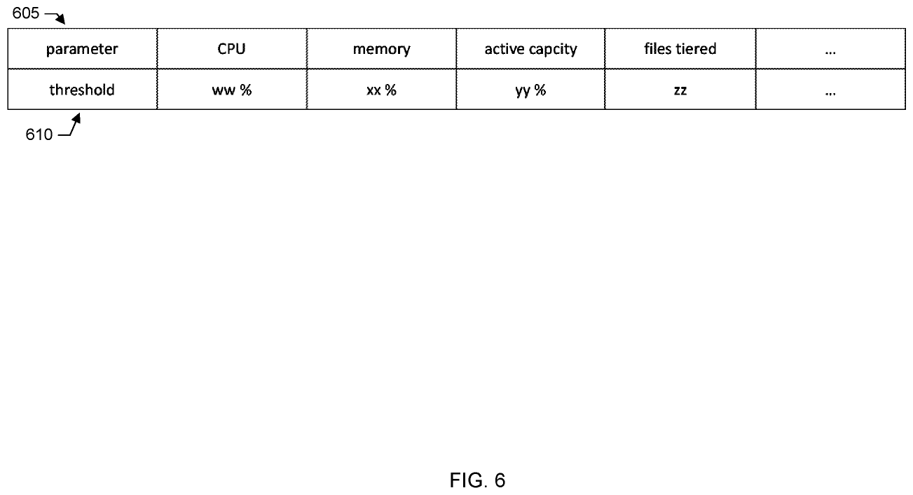

FIG. 6 shows an example of a threshold map. As shown in the example of FIG. 6, the threshold map lists parameters 605 (e.g., CPU, memory, active capacity, files tiered, and so forth) along with corresponding threshold values 610 for the parameters. Depending on the parameter, a threshold value may be expressed as a percent value, absolute value, or range of values. In an embodiment, the predicted values of the parameters are compared against the threshold values in the threshold map to determine whether or not a workflow should be triggered.

The system may be configured to require that all threshold values be satisfied in order for the workflow to be triggered. Alternatively, the system may be configured to require only a subset of the threshold values be satisfied in order for the workflow to be triggered. Further, different parameters may be assigned different levels of importance or weights. For example, the active capacity parameter may be expressed as a percentage of space used. Storage space available can be considered an important parameter because running out of storage space would result in the storage appliance being unable to accept new incoming data. Thus, the system may be configured such that a cloud tiering or migration workflow is triggered when active capacity is predicted to reach a threshold level (e.g., 95 percent storage space used) despite other parameters such as CPU, memory, or both not being satisfied.

The predicted data-movements statistics such as eligible files and data to be migrated are used to ensure enough churn is available for migration. Additionally, the time since “last migration run” is also considered to avoid runs being too frequent. The predicted resource utilization values are used to identify whether utilization will be low all throughout the predicted migration run time.

The capacity utilization prediction can also be considered as an additional parameter to make the decision on triggering the migration workflow. If the predicted capacity is expected to cross the set threshold before a next scheduled run, then data-movement can be triggered to avoid an active space full scenario.

The prediction module, equipped with statistical models, receives a prediction request from the dynamic trigger. In an embodiment, the statistical model configured to be used for prediction of a particular parameter is trained on 80 percent of the heuristics data set and tested on the rest or remaining 20 percent. The accuracy of the model is measured with a root mean square error (RMSE). If the accuracy is not high enough or sufficient, the orders of the statistical model are re-calibrated and tested again until a desired level of accuracy is reached or a maximum or threshold number of re-trainings is reached. The most optimal orders are then used to make the predictions which are returned to the “dynamic trigger” to check the predicted values against the thresholds from the map.

The predication requests are made for each parameter. The predicted values of the parameters are then used to make the decision on migration invocation. For data-movement statistics, resource utilization, and capacity utilization predictions, a technique employs a time series prediction model referred to as Seasonal Auto-Regressive Integrated Moving Average (SARIMA) which analyses the past patterns and also accounts seasonality. This suits the time-series prediction requirements for auto-triggering a data-movement workflow.

In an embodiment, an automatic stop helps prevent the data-movement workflow from interfering with other jobs or workflows having a higher priority. If the resource utilization is not low throughout the predicted run-time, or is going to overlap with other scheduled long-running jobs like garbage collection and replication, then the data-movement workflow can be suspended or stopped. The data-movement workflow can be suspended or stopped if the workflow does not complete within the allotted window of time, actual resource utilization exceeds the predicted resource utilization within the allotted window of time, or both.

In an embodiment, a preset schedule and auto-trigger for the cloud migration workflow can co-exist. In an embodiment, the auto-trigger can be more conservative and be invoked only when all dynamic trigger conditions are satisfied, whereas schedule runs can guarantee migration even if all the conditions for auto-trigger are not met, thereby ensuring the balance between migration and ingest is maintained. In order to avoid frequent runs, the automatic trigger can check the “last invocation” time of a migration run or predicted chum value to take decision on invocation.

In another embodiment, the schedule and auto-trigger can also be made mutually exclusive where the system can either have the schedule or auto-trigger. The auto-trigger in such a case can be more liberal, where even if all conditions such as low predicted resource utilization is not met, data-movement may still be triggered if capacity is predicted to cross the threshold or enough data is expected to be eligible.

In an embodiment, the predicted values can be used to enhance the user experience by providing an approximate estimation on the tiering workflow which otherwise are computationally expensive and time-consuming. In particular, tiering statistical estimations such as eligible files, pre-compression and post-compression sizes of data to be migrated, total run time can be provided, which otherwise are not available beforehand. The estimated statistics may be reported to the end-user to enhance the user experience.

The capacity utilization predictions can be reported along with current system capacity status to help the end-user better plan the storage space full scenario handling. Trending information regarding space utilization of the active tier, cloud tier, as well as cloud metadata storage on the active tier, can be used to predict the time by which a respective storage will be full.

In an embodiment, the technique of predictive intelligence is applied to a cloud tiering workflow. In another embodiment, similar to cloud tiering, a workflow to restore the data from cloud storage back to the local storage appliance can also be enhanced with predictive intelligence. The restore use-case differs from that of cloud tiering in terms of load, invocation, cost, and urgency. The predictive intelligence can be used to identify an optimal or desirable window for invocation when resource utilization is low. Additionally, the recall migration time and destination (active tier) post-compression can be estimated to enhance the user experience and space management. The estimated post-compression can also be used to estimate egress cost.

In a scale-out architecture, predictive intelligence can be used to load balance across a sub-set of services while cloud tiering. The estimations made from predictions of migration eligible data can be used to scale tiering by spawning new services for high-load, thus improving performance with optimal or desirable node resource utilization.

In an embodiment, systems and techniques are provided to use SARIMA-based predictive intelligence to forecast resource utilization, capacity utilization, and tiering run statistics to perform efficient cloud tiering, thereby improving backup service level agreements (SLAs) and address scheduling problems. Predictive intelligence may be inbuilt into the filesystem/tiering solution instead of analytics running on a backup client or telemetry analytics server. The use of forecasted resource utilization for tiering invocation improves performance through better resource utilization because the probability of migration overlapping with other resource intensive background jobs is lower.

In an embodiment, an automatic suspend and resume trigger with check-pointing facilitates optimal or desirable resource utilization without any re-work as tiering resumes from the checkpoint. Accounting for churn to trigger data-movement helps mitigate metadata bloat and provides for efficient metadata usage. The use of predicted values can enhance end-user reported status for the tiering workflow. The estimated migration eligible data for both cloud tiering and recall/restore can be used to derive the ingress and egress cost. Predictive intelligence, as discussed, can be used in a scale-out architecture to load balance across a sub-set of services, based on predictions for migration eligible data and spawn new services to improve performance.

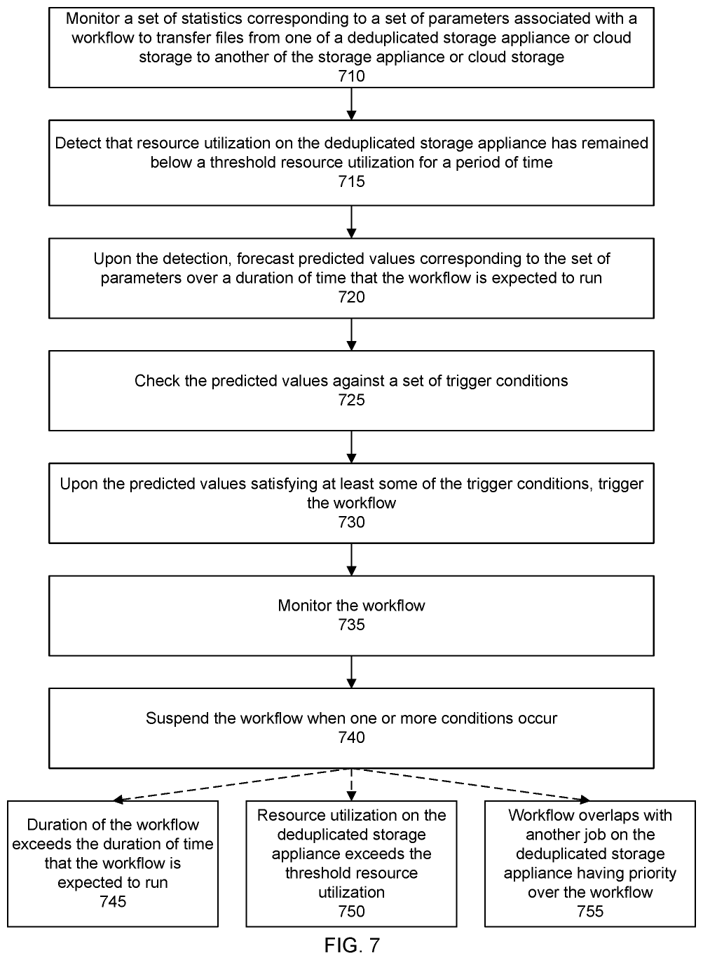

FIG. 7 shows another flow of predictive intelligence for a cloud tiering or recall workflow. Some specific flows are presented in this application, but it should be understood that the process is not limited to the specific flows and steps presented. For example, a flow may have additional steps (not necessarily described in this application), different steps which replace some of the steps presented, fewer steps or a subset of the steps presented, or steps in a different order than presented, or any combination of these. Further, the steps in other embodiments may not be exactly the same as the steps presented and may be modified or altered as appropriate for a particular process, application or based on the data.

In a step 710, statistics or metrics corresponding to parameters associated with a workflow to transfer files from one of a deduplicated storage appliance or cloud storage to another of the storage appliance or the cloud storage is monitored. In an embodiment, the workflow includes migrating the files from the storage appliance to cloud storage. In another embodiment, the workflow includes recalling or restoring the files from cloud storage back to the storage appliance. The parameters may include CPU utilization, memory utilization, percentage of available capacity remaining, number of files marked eligible for migration, and other parameters.

In a step 715, a determination is made from the monitoring that resource utilization on the storage appliance has remained low or below a threshold level for a period of time. The threshold level and time period are configurable values. For example, the monitoring module may observe that CPU utilization has remained below a first threshold level for a first period of time, that memory utilization has remained below a second threshold level for a second period of time, and so forth.

In a step 720, upon the determination, a forecast is made to predict values corresponding to the parameters over a duration of time that the workflow is expected to run. More specifically, the monitoring module issues a forecast request to the prediction module requesting predictions of, for example, CPU utilization, memory utilization, and other parameters for the duration of time that the workflow is expected to run.

In a step 725, the predicted values are checked against a set of trigger conditions maintained in the threshold map.

In a step 730, upon the predicted values satisfying at least some of the trigger conditions, the workflow is triggered. In an embodiment, the system can be configured to require that all of the trigger conditions be satisfied before the workflow is triggered. As an example, consider that CPU utilization is predicted to be 30 percent of total CPU capacity over the duration of time that the workflow is expected to run and memory utilization is predicted to be 40 percent over the duration of time that the workflow is expected to run. The trigger conditions in the threshold map may specify a CPU utilization threshold to not exceed 40 percent and a memory utilization threshold to not exceed 50 percent. In this example, all predicted values satisfy the conditions for triggering the workflow.

In a step 735, the workflow is monitored.

In a step 740, the workflow may be temporarily suspended or paused when one or more of a set of conditions occur. In particular, in a step 745, the workflow may be suspended when a duration of the workflow exceeds the duration of time that the workflow is predicted to run. In a step 750, the workflow may be suspended when resource utilization on the storage appliance exceeds a threshold resource utilization. There can be thresholds for resources such as CPU and memory that are not to be exceeded while the workflow is in progress so as to help ensure that the resources are available to satisfy other production requests. For example, the system may be configured to specify that CPU utilization is to remain below 85 percent and that memory utilization is to remain below 95 percent. In this example, if CPU utilization exceeds 85 percent, memory utilization exceeds 95 percent, or both while the workflow is in progress, the workflow may be suspended. In a step 755, the workflow may be suspended if the workflow happens to overlap with another job on the storage appliance having priority over the workflow.

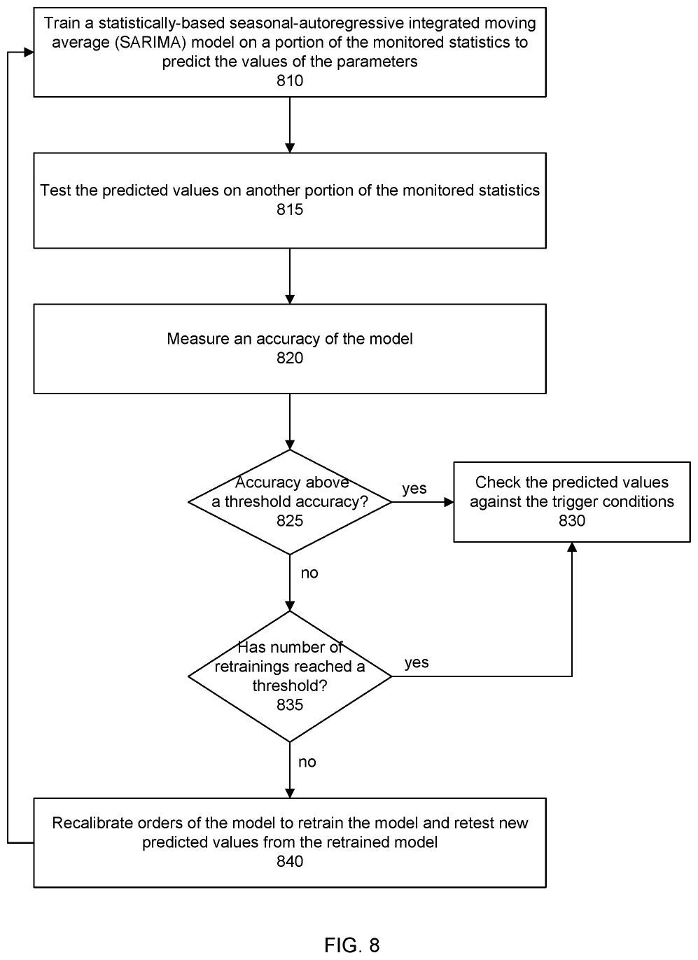

FIG. 8 shows a flow for using a SARIMA model to make workflow scheduling decisions. In an embodiment, the SARIMA model is used to generate a forecast of predicted values (step 720-FIG. 7) corresponding to parameters associated with the workflow. In a step 810, a statistically-based seasonal-autoregressive integrated moving average (SARIMA) model is trained on a portion of the monitored statistics to predict the values of the parameters. In a step 815, the predicted values are tested on another portion of the monitored statistics.

In a step 820, an accuracy of the model is measured. As discussed, in an embodiment, the model is trained using 80 percent of the data set, predictions are made for the remaining 20 percent of the data set, and deviations between the predictions and actual values contained in the remaining 20 percent of the data set are calculated to assess an accuracy of the model. It should be appreciated that any portion of the data set may be partitioned into a training set with the remaining portion being used to test the accuracy of predictions. In a step 825, a determination is made as to whether the accuracy is above a threshold accuracy. If the accuracy is above the threshold accuracy, in a step 830, the predicted values are checked against the conditions for triggering the workflow.

Alternatively, if the accuracy is below the threshold accuracy, in a step 835, a determination is made as to whether a threshold number of times the model has been retrained is reached. If the threshold number of retrainings has been reached, the predicted values are checked against the conditions for triggering the workflow (step 830).

Alternatively, in a step 840, one or more orders of the model are recalibrated to retrain the model, make new predictions, and retest new predicted values from the retained model. For example, as discussed, components of the SARIMA model (or the “P”, “D”, “Q” and “sn” order of a SARIMA model) may be tuned, modified, or changed to find an appropriate fit for the data.

The order of the SARIMA model helps determine the number of past observations that the model uses to make its predictions. If the order is too high, the model may overfit the data and may not generalize well to new data. If the order is too low, the model may under-fit the data and may not capture all of the patterns in the data. The values for “P”, “D”, “Q” and “sn” can be changed or tuned in order to fit the model to the training data and reach a desired level of accuracy. Once fit, the model is used to make a forecast or prediction of values corresponding to parameters associated with the workflow (e.g., CPU utilization, memory utilization, and so forth) for the duration of time that the workflow is expected to run.

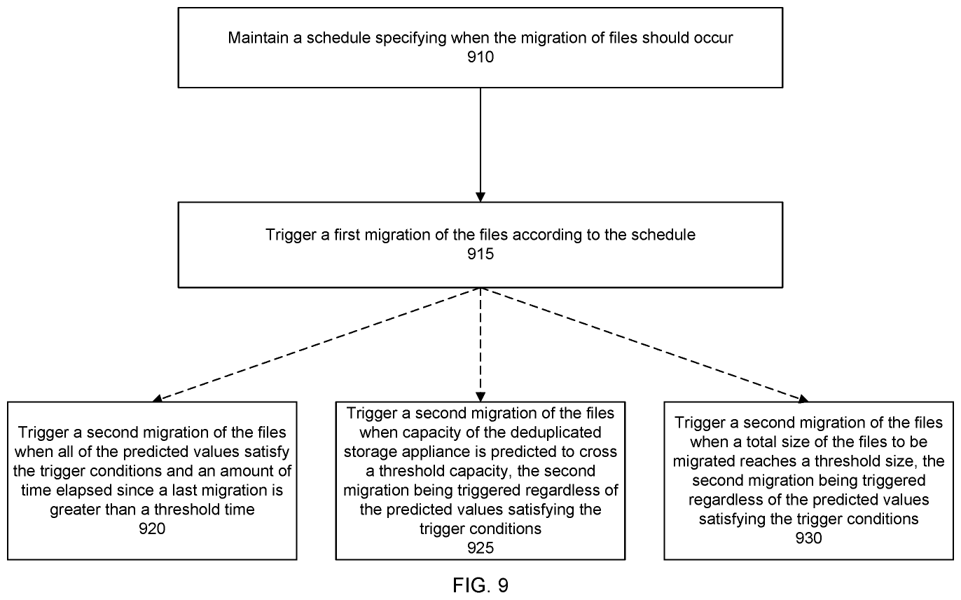

FIG. 9 shows a flow of predictive intelligence for a cloud migration workflow being used in conjunction with a predetermined schedule for the cloud migration workflow. In a step 910, a schedule is maintained specifying when the migration of files from the storage appliance to cloud storage should occur. In a step 915, a first migration of the files is triggered according to the schedule.

A second migration of the files may be triggered when all of the predicted values for the parameters (e.g., CPU utilization, memory utilization, and others) satisfy the trigger conditions and an amount of time elapsed since a last migration is greater than a threshold time (step 920).

Alternatively, a second migration of the files may be triggered when capacity of the storage appliance is predicted to cross a threshold capacity. This second migration may be triggered regardless of the predicted values satisfying the trigger conditions. This helps to ensure that the storage appliance does not run out of storage space to accept new incoming data.

Alternatively, a second migration of the files may be triggered when a total size of the files to be migrated reaches a threshold size. This second migration may be triggered regardless of the predicted values satisfying the trigger conditions.

The schedule can be used as a fallback to help ensure that a cloud tiering or migration workflow will, at some point, eventually be triggered.

To prove operability, SARIMA and liner regression models were trained on statistics collected from a field deployed PowerProtect DD9900 system, as provided by Dell, generated over a duration of around 6 months. The models were trained on 80 percent of the data set and tested on the remaining 20 percent. Prediction was performed with SARIMA for migration statistics-“files migrated”, resource utilization-CPU, memory, disk, and with linear regression for capacity utilization-active tier. The root mean square error signifying the deviation of predicted values from expected values are shown in table A below. As discussed, the accuracy of the model can be increased by fine tuning the orders of regression and seasonality.

TABLE A

| Model | Prediction parameter | Root Mean Squared Error (RMSE) |
|---|---|---|
| SARIMA | Migration eligible files | 1.8463148071930955 |
| | CPU utilization | 8.009525225166866 |
| | Disk utilization | 41.052086043692064 |
| | Memory utilization | 0.35634175419662806 |
| Linear regression | Capacity utilization (Active Tier) | 4652.62 |

For capacity utilization, linear regression is not well suited as it does not consider the drop in utilization (seasonality) generated because of garbage collection.

In an embodiment, a method includes: monitoring a plurality of statistics corresponding to a plurality of parameters associated with a workflow to transfer files from one of a deduplicated storage appliance or a cloud storage to another of the deduplicated storage appliance or the cloud storage; detecting that resource utilization on the deduplicated storage appliance has remained below a threshold resource utilization for a period of time; upon the detecting, forecasting predicted values corresponding to the plurality of parameters over a duration of time that the workflow is expected to run; checking the predicted values against a plurality of trigger conditions; and upon the predicted values satisfying at least some of the plurality of trigger conditions, triggering the workflow.

In an embodiment, the forecasting includes: training a statistically-based seasonal-autoregressive integrated moving average (SARIMA) model on a portion of the monitored statistics to predict the values of the plurality of parameters; testing the predicted values on another portion of the monitored statistics; measuring an accuracy of the model; determining that the accuracy of the model is below a threshold accuracy; upon the determination, recalibrating orders of the model to retrain the model, forecasting new predicted values, and retesting the new predicted values using the retrained model; and repeating the recalibrating, forecasting, and retesting until at least one of the threshold accuracy is reached or a threshold number of times the model has been retrained is reached.

The method may include: monitoring the workflow; and suspending the workflow when one or more of a duration of the workflow exceeds the duration of time that the workflow is expected to run occurs, the resource utilization on the deduplicated storage appliance exceeds the threshold resource utilization, or the workflow overlaps with another job on the deduplicated storage appliance having priority over the workflow.

In an embodiment, the workflow comprises migrating the files from the deduplicated storage appliance to the cloud storage and the method further comprises: maintaining a schedule specifying when the migration of the files should occur; and triggering the migration of the files according to the schedule and regardless of whether the resource utilization on the deduplicated storage appliance has remained below the threshold resource utilization for the period of time.

In an embodiment, the workflow comprises migrating the files from the deduplicated storage appliance to the cloud storage and the method further comprises: maintaining a schedule specifying when the migration of the files should occur; triggering the migration of the files according to the schedule; and triggering another migration of the files when all of the predicted values satisfy the plurality of trigger conditions, and an amount of time elapsed since a last migration of the files is greater than a threshold time.

In an embodiment, the workflow comprises migrating the files from the deduplicated storage appliance to the cloud storage and the method further comprises: maintaining a schedule specifying when the migration of the files should occur; triggering a first migration according to the schedule; and triggering a second migration when capacity of the deduplicated storage appliance is predicted to cross a threshold capacity, wherein the second migration is triggered regardless of whether all of the predicted values satisfy the plurality of trigger conditions.

In an embodiment, the workflow comprises migrating the files from the deduplicated storage appliance to the cloud storage and the method further comprises: maintaining a schedule specifying when the migration of the files should occur; triggering a first migration according to the schedule; and triggering a second migration when a total size of the files to be migrated reaches a threshold size, wherein the second migration is triggered regardless of whether all of the predicted values satisfy the plurality of trigger conditions.

In another embodiment, there is a system comprising: a processor; and memory configured to store one or more sequences of instructions which, when executed by the processor, cause the processor to carry out the steps of: monitoring a plurality of statistics corresponding to a plurality of parameters associated with a workflow to transfer files from one of a deduplicated storage appliance or a cloud storage to another of the deduplicated storage appliance or the cloud storage; detecting that resource utilization on the deduplicated storage appliance has remained below a threshold resource utilization for a period of time; upon the detecting, forecasting predicted values corresponding to the plurality of parameters over a duration of time that the workflow is expected to run; checking the predicted values against a plurality of trigger conditions; and upon the predicted values satisfying at least some of the plurality of trigger conditions, triggering the workflow.

In another embodiment, there is a computer program product, comprising a non-transitory computer-readable medium having a computer-readable program code embodied therein, the computer-readable program code adapted to be executed by one or more processors to implement a method comprising: monitoring a plurality of statistics corresponding to a plurality of parameters associated with a workflow to transfer files from one of a deduplicated storage appliance or a cloud storage to another of the deduplicated storage appliance or the cloud storage; detecting that resource utilization on the deduplicated storage appliance has remained below a threshold resource utilization for a period of time; upon the detecting, forecasting predicted values corresponding to the plurality of parameters over a duration of time that the workflow is expected to run; checking the predicted values against a plurality of trigger conditions; and upon the predicted values satisfying at least some of the plurality of trigger conditions, triggering the workflow.

Referring back now to FIG. 1, the clients may include servers, desktop computers, laptops, tablets, smartphones, internet of things (IoT) devices, or combinations of these. The data protection backup storage system receives requests from the clients, performs processing required to satisfy the requests, and forwards the results corresponding to the requests back to the requesting client system. The processing required to satisfy the request may be performed by the data protection storage appliance or may alternatively be delegated to other servers connected to the network.

The network may be a cloud network, local area network (LAN), wide area network (WAN) or other appropriate network. The network provides connectivity to the various systems, components, and resources of the system, and may be implemented using protocols such as Transmission Control Protocol (TCP) and/or Internet Protocol (IP), well-known in the relevant arts. In a distributed network environment, the network may represent a cloud-based network environment in which applications, servers and data are maintained and provided through a centralized cloud computing platform. In an embodiment, the system may represent a multi-tenant network in which a server computer runs a single instance of a program serving multiple clients (tenants) in which the program is designed to virtually partition its data so that each client works with its own customized virtual application, with each virtual machine (VM) representing virtual clients that may be supported by one or more servers within each VM, or other type of centralized network server.

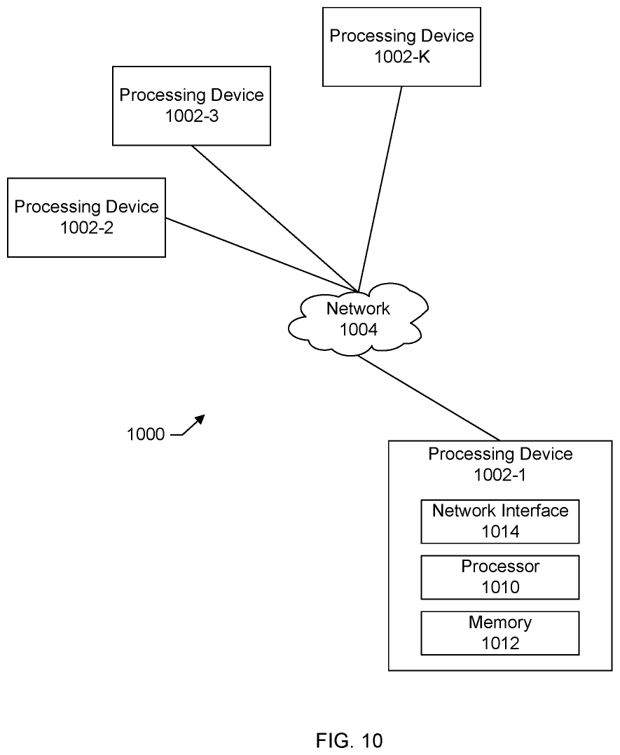

FIG. 10 shows an example of a processing platform 1000 that may include at least a portion of the information handling system shown in FIG. 1. The example shown in FIG. 10 includes a plurality of processing devices, denoted 1002-1, 1002-2, 1002-3, . . . 1002-K, which communicate with one another over a network 1004.

The network 1004 may comprise any type of network, including by way of example a global computer network such as the Internet, a WAN, a LAN, a satellite network, a telephone or cable network, a cellular network, a wireless network such as a WiFi or WiMAX network, or various portions or combinations of these and other types of networks.

The processing device 1002-1 in the processing platform 1000 comprises a processor 1010 coupled to a memory 1012.

The processor 1010 may comprise a microprocessor, a microcontroller, an application-specific integrated circuit (ASIC), a field-programmable gate array (FPGA) or other type of processing circuitry, as well as portions or combinations of such circuitry elements.

The memory 1012 may comprise random access memory (RAM), read-only memory (ROM) or other types of memory, in any combination. The memory 1012 and other memories disclosed herein should be viewed as illustrative examples of what are more generally referred to as “processor-readable storage media” storing executable program code of one or more software programs.

Articles of manufacture comprising such processor-readable storage media are considered illustrative embodiments. A given such article of manufacture may comprise, for example, a storage array, a storage disk or an integrated circuit containing RAM, ROM or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 1002-1 is network interface circuitry 1014, which is used to interface the processing device with the network 1004 and other system components, and may comprise conventional transceivers.

The other processing devices 1002 of the processing platform 1000 are assumed to be configured in a manner similar to that shown for processing device 1002-1 in the figure.

Again, the particular processing platform 1000 shown in the figure is presented by way of example only, and the information handling system may include additional or alternative processing platforms, as well as numerous distinct processing platforms in any combination, with each such platform comprising one or more computers, servers, storage devices or other processing devices.

For example, other processing platforms used to implement illustrative embodiments can comprise different types of virtualization infrastructure, in place of or in addition to virtualization infrastructure comprising virtual machines. Such virtualization infrastructure illustratively includes container-based virtualization infrastructure configured to provide Docker containers or other types of LXCs.

As another example, portions of a given processing platform in some embodiments can comprise converged infrastructure such as VxRail™, VxRack™, VxRack™ FLEX, VxBlock™, or Vblock® converged infrastructure from VCE, the Virtual Computing Environment Company, now the Converged Platform and Solutions Division of Dell EMC.

It should therefore be understood that in other embodiments different arrangements of additional or alternative elements may be used. At least a subset of these elements may be collectively implemented on a common processing platform, or each such element may be implemented on a separate processing platform.

Also, numerous other arrangements of computers, servers, storage devices or other components are possible in the information processing system. Such components can communicate with other elements of the information processing system over any type of network or other communication media.

As indicated previously, components of an information processing system as disclosed herein can be implemented at least in part in the form of one or more software programs stored in memory and executed by a processor of a processing device. For example, at least portions of the functionality of one or more components of the compute services platform 100 are illustratively implemented in the form of software running on one or more processing devices.

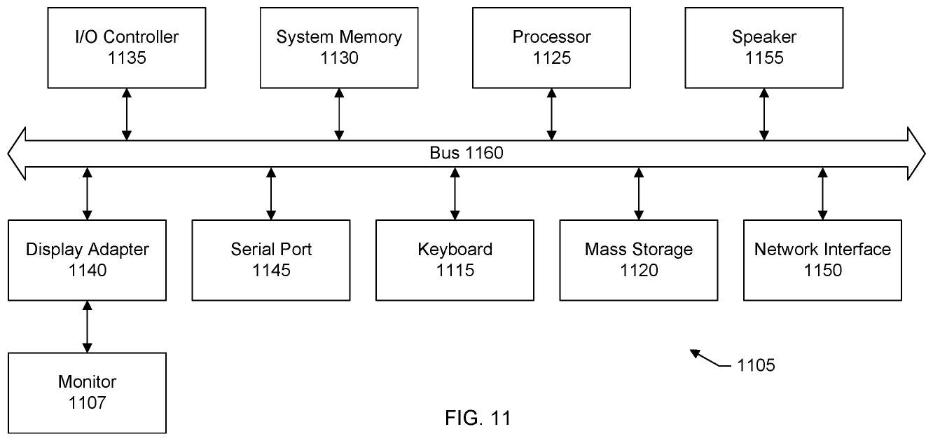

FIG. 11 shows a system block diagram of a computer system 1105 used to execute the software of the present system described herein. The computer system includes a monitor 1107, keyboard 1115, and mass storage devices 1120. Computer system 1105 further includes subsystems such as central processor 1125, system memory 1130, input/output (I/O) controller 1135, display adapter 1140, serial or universal serial bus (USB) port 1145, network interface 1150, and speaker 1155. The system may also be used with computer systems with additional or fewer subsystems. For example, a computer system could include more than one processor 1125 (i.e., a multiprocessor system) or a system may include a cache memory.

Arrows such as 1160 represent the system bus architecture of computer system 1105. However, these arrows are illustrative of any interconnection scheme serving to link the subsystems. For example, speaker 1155 could be connected to the other subsystems through a port or have an internal direct connection to central processor 1125. The processor may include multiple processors or a multicore processor, which may permit parallel processing of information. Computer system 1105 shown in FIG. 11 is but an example of a computer system suitable for use with the present system. Other configurations of subsystems suitable for use with the present invention will be readily apparent to one of ordinary skill in the art.

Computer software products may be written in any of various suitable programming languages. The computer software product may be an independent application with data input and data display modules. Alternatively, the computer software products may be classes that may be instantiated as distributed objects. The computer software products may also be component software.

An operating system for the system may be one of the Microsoft Windows®. family of systems (e.g., Windows Server), Linux, Mac OS X, IRIX32, or IRIX64. Other operating systems may be used. Microsoft Windows is a trademark of Microsoft Corporation.

Furthermore, the computer may be connected to a network and may interface to other computers using this network. The network may be an intranet, internet, or the Internet, among others. The network may be a wired network (e.g., using copper), telephone network, packet network, an optical network (e.g., using optical fiber), or a wireless network, or any combination of these. For example, data and other information may be passed between the computer and components (or steps) of a system of the invention using a wireless network using a protocol such as Wi-Fi (IEEE standards 802.11, 802.11a, 802.11b, 802.11e, 802.11g, 802.11i, 802.11n, 802.11ac, and 802.11ad, just to name a few examples), near field communication (NFC), radio-frequency identification (RFID), mobile or cellular wireless. For example, signals from a computer may be transferred, at least in part, wirelessly to components or other computers.

In the description above and throughout, numerous specific details are set forth in order to provide a thorough understanding of an embodiment of this disclosure. It will be evident, however, to one of ordinary skill in the art, that an embodiment may be practiced without these specific details. In other instances, well-known structures and devices are shown in block diagram form to facilitate explanation. The description of the preferred embodiments is not intended to limit the scope of the claims appended hereto. Further, in the methods disclosed herein, various steps are disclosed illustrating some of the functions of an embodiment. These steps are merely examples, and are not meant to be limiting in any way. Other steps and functions may be contemplated without departing from this disclosure or the scope of an embodiment. Other embodiments include systems and non-volatile media products that execute, embody or store processes that implement the methods described above.

What is claimed is:

1. A method comprising:
monitoring a plurality of statistics corresponding to a plurality of parameters associated with a workflow to transfer files from one of a deduplicated storage appliance or a cloud storage to another of the deduplicated storage appliance or the cloud storage;
detecting that resource utilization on the deduplicated storage appliance has remained below a threshold resource utilization for a period of time;
upon the detecting, forecasting predicted values corresponding to the plurality of parameters over a duration of time that the workflow is expected to run;
checking the predicted values against a plurality of trigger conditions; and
upon the predicted values satisfying at least some of the plurality of trigger conditions, triggering the workflow.

2. The method of claim 1 wherein the forecasting comprises:
training a statistically-based seasonal-autoregressive integrated moving average (SARIMA) model on a portion of the monitored statistics to predict the values of the plurality of parameters;
testing the predicted values on another portion of the monitored statistics;
measuring an accuracy of the model;
determining that the accuracy of the model is below a threshold accuracy;
upon the determination, recalibrating orders of the model to retrain the model, forecasting new predicted values, and retesting the new predicted values using the retrained model; and
repeating the recalibrating, forecasting, and retesting until at least one of the threshold accuracy is reached or a threshold number of times the model has been retrained is reached.

3. The method of claim 1 further comprising:
monitoring the workflow; and
suspending the workflow when one or more of a duration of the workflow exceeds the duration of time that the workflow is expected to run occurs, the resource utilization on the deduplicated storage appliance exceeds the threshold resource utilization, or the workflow overlaps with another job on the deduplicated storage appliance having priority over the workflow.

4. The method of claim 1 wherein the workflow comprises migrating the files from the deduplicated storage appliance to the cloud storage and the method further comprises:
maintaining a schedule specifying when the migration of the files should occur; and
triggering the migration of the files according to the schedule and regardless of whether the resource utilization on the deduplicated storage appliance has remained below the threshold resource utilization for the period of time.

5. The method of claim 1 wherein the workflow comprises migrating the files from the deduplicated storage appliance to the cloud storage and the method further comprises:
maintaining a schedule specifying when the migration of the files should occur;
triggering the migration of the files according to the schedule; and
triggering another migration of the files when all of the predicted values satisfy the plurality of trigger conditions, and an amount of time elapsed since a last migration of the files is greater than a threshold time.

6. The method of claim 1 wherein the workflow comprises migrating the files from the deduplicated storage appliance to the cloud storage and the method further comprises:
maintaining a schedule specifying when the migration of the files should occur;
triggering a first migration according to the schedule; and
triggering a second migration when capacity of the deduplicated storage appliance is predicted to cross a threshold capacity, wherein the second migration is triggered regardless of whether all of the predicted values satisfy the plurality of trigger conditions.

7. The method of claim 1 wherein the workflow comprises migrating the files from the deduplicated storage appliance to the cloud storage and the method further comprises:
maintaining a schedule specifying when the migration of the files should occur;
triggering a first migration according to the schedule; and
triggering a second migration when a total size of the files to be migrated reaches a threshold size, wherein the second migration is triggered regardless of whether all of the predicted values satisfy the plurality of trigger conditions.

8. A system comprising: a processor; and memory configured to store one or more sequences of instructions which, when executed by the processor, cause the processor to carry out the steps of:
monitoring a plurality of statistics corresponding to a plurality of parameters associated with a workflow to transfer files from one of a deduplicated storage appliance or a cloud storage to another of the deduplicated storage appliance or the cloud storage;
detecting that resource utilization on the deduplicated storage appliance has remained below a threshold resource utilization for a period of time;
upon the detecting, forecasting predicted values corresponding to the plurality of parameters over a duration of time that the workflow is expected to run;
checking the predicted values against a plurality of trigger conditions; and
upon the predicted values satisfying at least some of the plurality of trigger conditions, triggering the workflow.

9. The system of claim 8 wherein the forecasting comprises:
training a statistically-based seasonal-autoregressive integrated moving average (SARIMA) model on a portion of the monitored statistics to predict the values of the plurality of parameters;
testing the predicted values on another portion of the monitored statistics;
measuring an accuracy of the model;
determining that the accuracy of the model is below a threshold accuracy;
upon the determination, recalibrating orders of the model to retrain the model, forecasting new predicted values, and retesting the new predicted values using the retrained model; and
repeating the recalibrating, forecasting, and retesting until at least one of the threshold accuracy is reached or a threshold number of times the model has been retrained is reached.

10. The system of claim 8 wherein the processor further carries out the steps of:
monitoring the workflow; and
suspending the workflow when one or more of a duration of the workflow exceeds the duration of time that the workflow is expected to run occurs, the resource utilization on the deduplicated storage appliance exceeds the threshold resource utilization, or the workflow overlaps with another job on the deduplicated storage appliance having priority over the workflow.

11. The system of claim 8 wherein the workflow comprises migrating the files from the deduplicated storage appliance to the cloud storage and the processor further carries out the steps of:
maintaining a schedule specifying when the migration of the files should occur; and
triggering the migration of the files according to the schedule and regardless of whether the resource utilization on the deduplicated storage appliance has remained below the threshold resource utilization for the period of time.

12. The system of claim 8 wherein the workflow comprises migrating the files from the deduplicated storage appliance to the cloud storage and the processor further carries out the steps of:
maintaining a schedule specifying when the migration of the files should occur;
triggering the migration of the files according to the schedule; and
triggering another migration of the files when all of the predicted values satisfy the plurality of trigger conditions, and an amount of time elapsed since a last migration of the files is greater than a threshold time.

13. The system of claim 8 wherein the workflow comprises migrating the files from the deduplicated storage appliance to the cloud storage and the processor further carries out the steps of:
maintaining a schedule specifying when the migration of the files should occur;
triggering a first migration according to the schedule; and
triggering a second migration when capacity of the deduplicated storage appliance is predicted to cross a threshold capacity, wherein the second migration is triggered regardless of whether all of the predicted values satisfy the plurality of trigger conditions.

14. A computer program product, comprising a non-transitory computer-readable medium having a computer-readable program code embodied therein, the computer-readable program code adapted to be executed by one or more processors to implement a method comprising:
monitoring a plurality of statistics corresponding to a plurality of parameters associated with a workflow to transfer files from one of a deduplicated storage appliance or a cloud storage to another of the deduplicated storage appliance or the cloud storage;
detecting that resource utilization on the deduplicated storage appliance has remained below a threshold resource utilization for a period of time;
upon the detecting, forecasting predicted values corresponding to the plurality of parameters over a duration of time that the workflow is expected to run;
checking the predicted values against a plurality of trigger conditions; and
upon the predicted values satisfying at least some of the plurality of trigger conditions, triggering the workflow.

15. The computer program product of claim 14 wherein the forecasting comprises:
training a statistically-based seasonal-autoregressive integrated moving average (SARIMA) model on a portion of the monitored statistics to predict the values of the plurality of parameters;
testing the predicted values on another portion of the monitored statistics;
measuring an accuracy of the model;
determining that the accuracy of the model is below a threshold accuracy;
upon the determination, recalibrating orders of the model to retrain the model, forecasting new predicted values, and retesting the new predicted values using the retrained model; and
repeating the recalibrating, forecasting, and retesting until at least one of the threshold accuracy is reached or a threshold number of times the model has been retrained is reached.

16. The computer program product of claim 14 wherein the method further comprises:
monitoring the workflow; and
suspending the workflow when one or more of a duration of the workflow exceeds the duration of time that the workflow is expected to run occurs, the resource utilization on the deduplicated storage appliance exceeds the threshold resource utilization, or the workflow overlaps with another job on the deduplicated storage appliance having priority over the workflow.

17. The computer program product of claim 14 wherein the workflow comprises migrating the files from the deduplicated storage appliance to the cloud storage and the method further comprises:
maintaining a schedule specifying when the migration of the files should occur; and
triggering the migration of the files according to the schedule and regardless of whether the resource utilization on the deduplicated storage appliance has remained below the threshold resource utilization for the period of time.

18. The computer program product of claim 14 wherein the workflow comprises migrating the files from the deduplicated storage appliance to the cloud storage and the method further comprises:
maintaining a schedule specifying when the migration of the files should occur;
triggering the migration of the files according to the schedule; and
triggering another migration of the files when all of the predicted values satisfy the plurality of trigger conditions, and an amount of time elapsed since a last migration of the files is greater than a threshold time.

19. The computer program product of claim 14 wherein the workflow comprises migrating the files from the deduplicated storage appliance to the cloud storage and the method further comprises:
maintaining a schedule specifying when the migration of the files should occur;
triggering a first migration according to the schedule; and
triggering a second migration when capacity of the deduplicated storage appliance is predicted to cross a threshold capacity, wherein the second migration is triggered regardless of whether all of the predicted values satisfy the plurality of trigger conditions.
